(19) United States
(12) Patent Application Publication
(10) Pub. No.: US 2006/0214106 A1
(43) Pub. Date: Sep. 28, 2006

(54) Point scanning laser scanning microscope and methods for adjustment of a microscope

(76) Inventors: Ralf Wolleschensky, Apolda (DE); Herbert Gross, Essingen (DE); Michael Kempe, Jena (DE)

Correspondence Address: JACOBSON HOLMAN PLLC, 400 SEVENTH STREET N.W., SUITE 600, WASHINGTON, DC, 20004, US

(21) Appl. No.: 11/364,544

(22) Filed: Mar. 1, 2006

(30) Foreign Application Priority Data
Mar. 1, 2005 (DE) 10 2005 009 188.1

(51) Int. Cl. G01J 5/02

(52) U.S. Cl. 250/341.2

(57) ABSTRACT

Point scanning Laser Scanning Microscope with an element arranged in or near a pupil plane of the beam path between the probe and detection for separation of illumination and detection beams, which element comprises a reflecting or transmitting first region for the transmission of the illumination beam and a transmitting or reflecting second region, lying essentially outside the first region, for the transmission of the probe light, whereby advantageously manipulating devices for the variation of the size and/or the form of the first and/or second region are provided and a method for the adjustment of the microscope with the element wherein the manipulation of the manipulating devices takes place by means of a control circuit.

### BACKGROUND OF THE INVENTION

1. Field of the Invention

The invention relates to methods and arrangements for microscopy, in particular for fluorescence microscopy, laser scanning microscopy, fluorescence correlation microscopy and scanning near-field microscopy, primarily for examination of biological samples, preparations and their components. It also includes methods for the screening of substances (High Throughput Screening) based on fluorescence detection and methods for flow cytometry. Thus, simultaneous examination in real time of probes with multiple fluorophores becomes possible through simultaneous illumination of a probe having several illumination wavelengths, with overlapping fluorescence spectra, even in spatial structures of thick probes. An achromatic main beam splitter for Laser Scanning Microscopy is realized, which enables efficient excitation and detection in confocal imaging with or without extension of the depth of sharpness and integration of the same in Laser Scanning Microscopes. Multiple-point illumination is also explicitly included.

2. Description of Related Art

A classical field of application of light microscopes in the examination of biological preparations is fluorescence microscopy. See for example: Pawley, “Handbook of Biological Confocal Microscopy” Plenum Press 1995. In accordance with the classic application, certain dyes are used for specific marking of cell parts.

In fluorescence microscopy, the fluorescence light from an excitation beam is split with suitable dichroitic beam splitters in combination with block filters and is observed separately. Imaging of individual differently stained cell parts is thus possible. However, in principle, several parts of the preparations can be stained at the same time with different specifically absorbed dyes (multiple fluorescence). To differentiate between the fluorescence signals emitted by the individual dyes, special dichroic beam splitters are used.

The state of the art is explained in the following example on the basis of a confocal Laser Scanning Microscope (LSM) shown in FIG. 1.

An LSM 10 comprises essentially 4 modules: light source 12, scan module 14, detection unit 16 and microscope 18. These modules are described in greater detail in the following description. In addition, reference is made to U.S. Pat. No. 6,167,173, which is incorporated by reference herein.

For specific excitation of the different dyes in a preparation, lasers 21-24 with different wavelengths are used in the LSM. The selection of the excitation wavelengths depends on the absorption characteristics of the dyes to be investigated. The excitation beam is generated in the light source module 12. Thereby different types of lasers are used (for example, glass laser: argon, argon krypton, solid state laser: TiSa laser, diodes). Furthermore, in a light source module, the selection of the wavelengths and the tuning of the intensity of the required excitation wavelengths is done, for instance, by using acoustooptical crystals 28,30. Thereafter, the laser beam reaches into the scan module 14 passing through a fiber 26 or a suitable mirror arrangement.

The laser beam generated in the light source is focused in diffraction limited manner by means of the objective 31, passing through the scanner 14, the scanning optical system 33 and the tube lens 35, onto the preparation 37. The scanner performs point-like rastering of the probe in x-y direction. The pixel dwell time during the scanning of the probe lies mostly in the range of less than a microsecond to a few seconds.

In the confocal detection (descanned detection) 16 of the fluorescence light, the light, which is emitted from the focal plane (specimen 37 and the planes above and below it, reaches, passing through the scanner, to a dichroitic beam splitter (HFT) 41. The latter separates the fluorescence light from the excitation light. Thereafter the fluorescence light is focused on a diaphragm (confocal diaphragm/pinhole) 43, which lies exactly on the plane conjugate to the focus plane. As a result, the portions of the fluorescence light outside the focus are suppressed. By varying the diaphragm size, the optical resolution of the microscope can be adjusted. Behind the diaphragm, there is another dichroic block filter EF1-EF4, which suppresses the excitation beam once again. After passing through the block filter EF1-EF4, the fluorescence is measured respectively by means of a point detector PMT1-PMT4.

In an application with multiphoton absorption, the excitation of the dye fluorescence takes place in a small volume in which the excitation intensity is especially high. This region is only insignificantly larger than the detected region in the applications with a confocal arrangement. Use of a confocal diaphragm is thus not necessary and the detection can take place directly after the objective (non-descanned detection) 49. In another arrangement for the detection of dye fluorescence excited with multiphoton absorption, descanned detection still does take place, however, in that case, the pupil of the objective is imaged in the detection unit (non-confocal descanned detection) 49.

Of a three-dimensionally illuminated image, only the plane (optical cross section) is reproduced by the confocal detection arrangement, which is located at the focal plane of the objective 31. Through the image data of the several optical cross sections in the x-y plane at different depths z of the probe, a computer-aided three-dimensional image of the probe can be recreated.

Therefore, the LSM 10 is suitable for examination of thick preparations. The excitation wavelengths are determined by the dye used according to its specific absorption characteristics. Dichroic filters tuned to the emission characteristics of the dye ensure that only the fluorescence light emitted by the respective dye is measured by the point detector.

In biomedical applications, in the present techniques, several different cell regions are marked simultaneously with different dyes (multifluorescence).

The individual dyes can be detected separately with state of the art technology on the basis of different absorption or emission characteristics (spectra).

For separate detection, additional splitting of the fluorescence light from several dyes takes place with secondary beam splitters DBS1-DBS3 and separate detection of the individual dye emissions in different point detectors PMT1-PMT4.

Flow cytometers are used in the examination and classification of cells and other particles. For that, the cells are dissolved in a liquid and are pumped by a capillary. To examine the cells, a laser beam is focused onto the capillary from a side. The cells are stained with different colors or fluorescent biomolecules.

What are measured are the excited fluorescence light and the backscattered excitation beam. The separation of the fluorescence signal of the probe from the excitation beam takes place by means of dichroic beam splitters (HFT see FIG. 1) 41.

The size of the cells can be determined from the backscattered signal. Based on the spectral characteristics of the fluorescence of the individual cells, different cells can be separated and/or sorted out or counted separately. The sorting out of the cells takes place by means of an electrostatic field in different capillaries. The result, that is, for instance, the number of the cells with stain A compared to cells with stain B, is frequently presented as histograms.

The flow rate is characteristically several 10-100 cm/s. Therefore, high-sensitivity detection is necessary. To limit the detection volume, the confocal detection takes place according to the state of the art.

In a Laser Scanning Microscope (LSM), according to the state of the art, the entire circular pupil is illuminated, due to which the main dye splitter (HFT) 41 is embodied as a dichroic splitter. This means that, for different excitation and detection wavelengths, different main dichroic splitters are required, which, mounted on a filter wheel, can then normally be swiveled in and out into the path of the beam.

Another alternative, known for a long time, for modifying the imaging characteristics of the microscope is to use special pupil illuminations. One possibility is to use an annular pupil illumination, which leads in particular to an extended depth of sharpness (C. J. R. Sheppard: The use of lenses with annular aperture in scanning optical microscopy, Optik 48 (1977) 329-334). Thereby, in combination with radial polarization, it also leads to increased resolution (C. J. R. Sheppard and A. Choudhury: Annular pupils, radial polarization, and superresolution, Appl. Opt. 43 (2004) 4322-4327). Other illuminations aimed at higher resolution are proposed in (T. Wilson and S. J. Hewlett: Superresolution in Confocal Microscopy, Op. Lett. 16(1991) 1062-1064). In confocal microscopy, illumination and detection take place in general with the same objective. Because of the heavy losses especially in detection with a highly limited pupil (for example one with an annular shape), use of such an objective aperture is out of the question at least in fluorescence microscopy. Besides that, some of the apertures described in T. Wilson et al have different limitations, such as, for example, extremely low excitation efficiency and asymmetrical Point Spread Function (PSF), which renders them in general not usable in confocal microscopy.

U.S. Pat. No. 6,809,324 B1, incorporated by reference herein in its entirety, describes an aperture division, in which the effective NA of the excitation is very low. The resolution of the excitation beam path is thus essentially worse than the resolution of the detection beam path. In general, the arrangement is used for suppressing the stray light (such as described in the Abstract and claim 1), whereby the probe is illuminated through a central part of the pupil with reduced NA (as described in claim 2). The same is true for the arrangement described in DE 299 13 707 U1.

In U.S. Pat. No. 6,785,302, incorporated by reference herein in its entirety, the exciting laser beam has a significantly smaller cross section than the fluorescence beam exiting from the objective (particularly as described in the Abstract and claim 1).

U.S. Pat. No. 6,888,148 describes an arrangement with a structured beam splitter for a line scanner and a far-field microscope. In both cases the non-point-like excitation of the probe takes place.

As further examples, the known use of a Nipkow disk represents a possible embodiment of multipoint scanners working parallel, as disclosed in U.S. Pat. No. 6,028,306 or U.S. Pat. No. 4,927,254 or U.S. Pat. No. 5,428,475. Besides that, the mentioned U.S. patent document describes a parallel scanning Laser Scanning Microscope with a multiaperture diaphragm plate, before which a corresponding microlens array is arranged, so that in the end, a multipoint source is generated. Other embodiments are related to fluorescence correlation spectroscopy (FCS), as described, for example, in U.S. Patent Application No. 2005/0271549 A1.

### SUMMARY OF THE INVENTION

The invention enables achromatic separation of the excitation and detection beam paths in a single-point or multipoint scanning LSM, that is, with point-like excitation and detection. In this way, the resolution of the excitation beam path remains almost the same or identical to the resolution in the detection beam path, whereby, surprisingly, it turns out that a nearly identical optical resolution of the microscope, as in the classical LSM with filled pupil, can be achieved by generating special spatially coherent illumination patterns.

Another advantage of the invention is that it enables special operation modes in which the depth of the sharpness of the microscope is higher compared to the classical single-point or multipoint scanning microscope.

Another advantage of the invention is the accomplishment of the automatic regulation of the illumination patterns in the pupil, depending on the operation mode (for example, small focus volume or enlarged focus volume).

This is achieved in that excitation light with a spatially coherent illumination pattern is formed at the location of a pupil of the microscope. In the pupil, an element is arranged, which reflects the illumination pattern in the direction of the probe. The remaining areas of the element are preferably transparent, so that the detection light, which fills the remaining area of the pupil, can pass in the direction of the detection. A possible reversal involves a transparent area for the transmission of the illumination beam to the probe and a remaining reflecting area for the transfer of the detection beam in the direction of a detection unit. The element for the separation of the beam can be rigid or flexible, with an adjustable or a replaceable structure.

### BRIEF DESCRIPTION OF THE DRAWINGS

FIG. 1 is a schematic diagram of a prior art Laser Scanning Microscope.

FIGS. 2, 2A and 2B are schematic diagrams of two embodiments of the main dichroic beam splitter arranged in the beam path.

FIG. 3 is a graphical representation a confocal PSF of the arrangement of FIG. 2.

FIG. 4 is diagram of a common HFT with three pupil radii.

FIG. 5 is graphical representation of a lateral PSF for two different sections.

FIG. 6 is schematic diagram of another embodiment using a freely programmable HFT.

FIG. 7 is a schematic diagram of an embodiment of the invention in which a micromirror array is used as an HFT.

FIG. 8 is a schematic diagram for a control circuit for automatically generating illumination patterns SF and patterns for the beam splitting at the HFT.

FIG. 9 schematically shows several examples of alternative HFTs.

FIG. 10 is a schematic diagram of the present invention in a multipoint scanning microscope.

FIGS. 11A and 11B are schematic diagrams illustrating arrangements of the invention for non-descanned detection in the context of multiphoton microscopes.

### DETAILED DESCRIPTION OF THE PREFERRED EMBODIMENTS

With the present invention, an achromatic beam splitter for a Laser Scanning Microscope is realized. In this way, compared to the state of the art, the splitter does not modify, or modifies only slightly, the characteristics of the image. To achieve the desired result, the main dichroic beam splitter is configured in the plane of the pupil (or near it) in such a way that it exhibits broad-band reflective function only in a certain region.

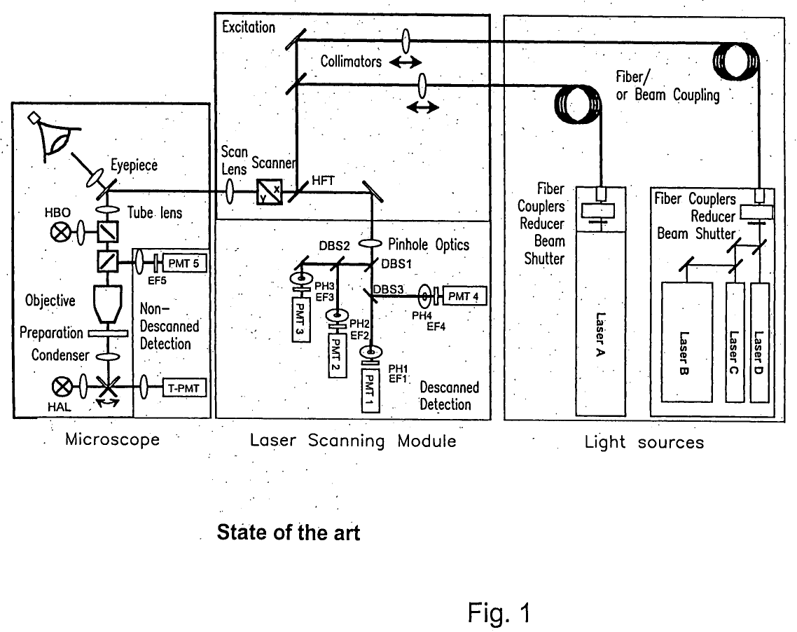

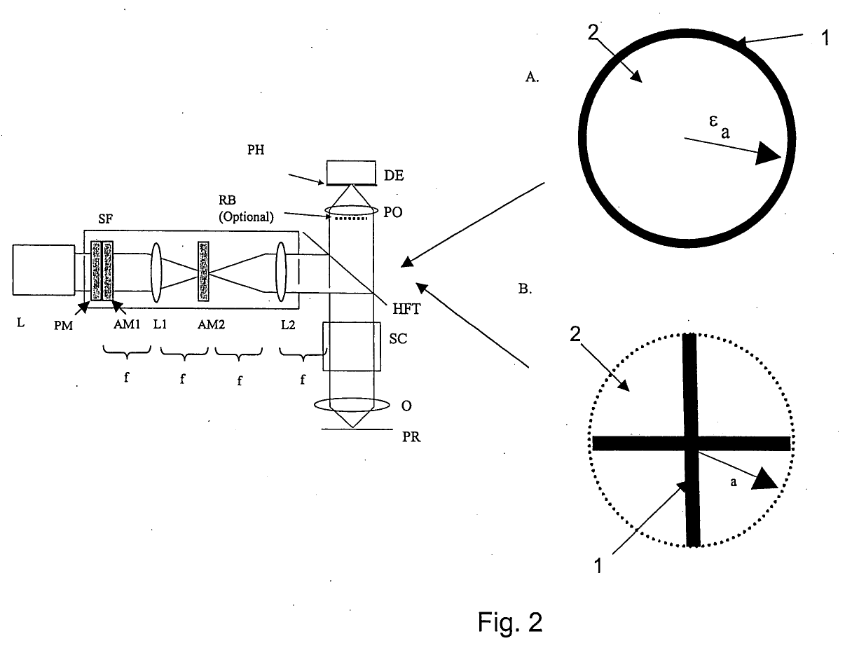

FIGS. 2, 2A and 2B show the first two advantageous embodiments of the main dichroic beam splitter and their arrangement in the beam path. Therein, a confocal LSM with a variable confocal diaphragm (according to FIG. 1) is provided. In contrast to the arrangement according to the state of the art technology, the main dichroic beam splitter HFT is arranged in or near a microscope pupil.

Light from the light source L arrives through a beam former SF to the beam splitter HFT and is reflected by it in the direction of the probe PR. The surface of the beam splitter is a vaporized coat reflector in the black area 1 so that the excitation is reflected in the direction of probe PR. The splitter is transparent in the remaining area 2.

With the excitation beam former SF, which is realized, for example, with a combination of phase masks PM and amplitude masks AM1, AM2 and classical optical system L1, L2 in the state of the art (for example, with diffractive or holographic elements (Such as described in “Diffractive optics improve product design,” Photonics Spectra, Laurin Publishing Co., Inc. September 1995)), the profile of the beam from the light source is influenced in such a manner that at the splitter HFT, it largely assumes the form of the structure of the splitter (area 1). With AM1, the amplitude of the beam profile can be influenced in the pupil. With the help of AM2, an additional spatial filter for the suppression of, for example, interfering diffraction orders that are generated by the PM or AM1, can be achieved. To that end, AM2 preferably takes the form of the illumination pattern at the location of the probe. For that, AM1 is arranged in or near a pupil and AM2 is arranged at an intermediate image. With that, a high efficiency is ensured in the excitation beam path. In the exemplary variants shown in FIG. 2, the distances between the elements PM/LI/AM/L2 and HFT are exactly f, where f is the focal length of the lenses L1 and L2 (focal lengths of the lenses need not be same). Diffractive optical elements DE for generating special patterns belong to the state-of-the art and are available (See, for example, Catalog No. 17, Thorlabs Inc. 2005, 639).

The fluorescence light generated in the probe arrives at the detector through the area 2 of the HFT. That part of the fluorescence light is lost, which is incident on the area 1. The detector is preferably embodied as a confocal detector, as in the state of the art. Further, devices for the suppression of the excitation light (for example emission filters) are arranged before the detector and after the HFT. In addition to that, the detection can take place simultaneously in several channels. This is achieved by arranging secondary dichroic splitters and more detectors as in FIG. 1.

Case A in FIG. 2A shows a circular shadowing of ε of the full objective pupil (inner ring diameter εₐ with the full radius of the pupil a (ε is a multiple of a) leads to an extension in the depth of sharpness by 1/(1−ε²)-times on the excitation side, a slightly reduced lateral full width at half maximum and to more distinct secondary maxima. The axial broadening and the amplitudes of the secondary maxima can be drastically reduced, if the excitation is done with a ring pupil, while the detection is done preferably confocally with a full aperture.

In the arrangement according to the invention as in FIG. 2, an undesirable side effect results due to the reduction in the size of the effective aperture on the detection side by the HFT. This results, first of all, in reduced detection efficiency. With 5%-shadowing of the pupil, it is possible, for example, that 95% of the fluorescence passes through the HFT. This can be improved further by further reduction of the ring width (96% detection efficiency at ε=0.02). In order to also make the excitation efficient, an annular beam former can be provided, for example with an Axicon or with a diffractive element before the HFT. Secondly, this reduction of the aperture leads to a modification in the image on the detection side. This effect is however negligible with illumination-sided shadowing of ε>0.9 on the illumination side or is compensated (in that area) through the tapering of the lateral extension of the PSF by the ring illumination.

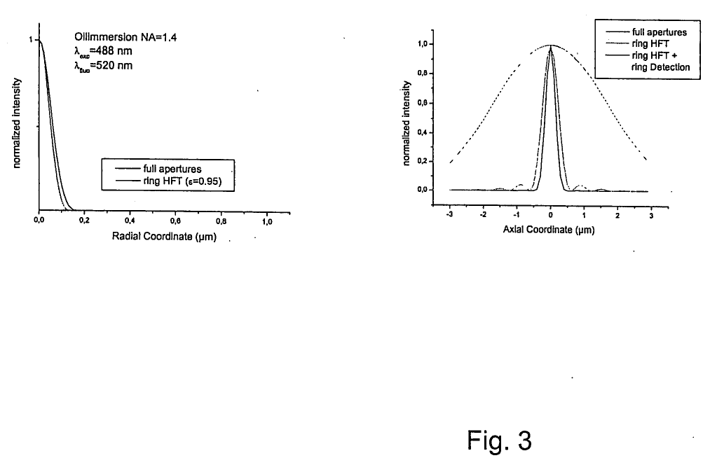

A confocal PSF in an arrangement according to FIG. 2 with ε=0.95 is shown in FIG. 3 in comparison to a PSF with full pupil. At the same time, one sees from the axial curve of the PSF that the detection over a circular aperture almost removes the effect of the extended depth of sharpness. That means that the use of the HFT according to the invention does not lead to significant negative changes in the image characteristics. However with the HFT according to the invention, targeted modifications in the PSF are possible.

If extended depth of sharpness is desired and the losses on the detection side do not play a role, an additional ring diaphragm RB (approximately of the same size as in the HFT) can be placed before the pinhole optics (see FIG. 2).

One can achieve improved lateral resolution by using a laser beam with radial polarization (Shepard et al as cited above). The corresponding optics can be provided in the beam former part in FIG. 2 and can be based for example on a LCD (M. Stalder, M. Schadt: Linearly polarized light with axial symmetry generated by liquid-crystal polarization converters, Opt. Lett. 21(1996) 1948-1950).

In order to take the fact into account that different objectives have different pupil radii, different main dichroic splitters can be mounted on a filter wheel and can be swiveled in according to the objective. In addition to that, dichroic HFT can also be mounted on the filter wheel in order to enable operation of the LSM according to the state of the art. Use of different ring apertures becomes naturally unnecessary, if zoom optics are provided between the HFT and the objective for adjusting the beam to different objectives.

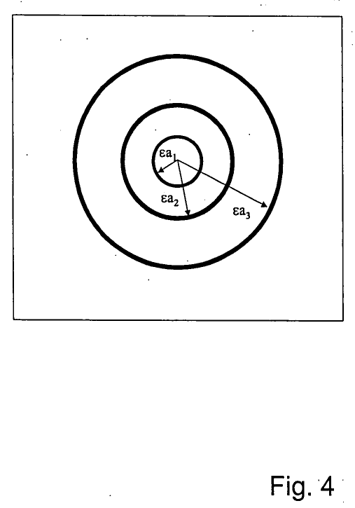

An alternative solution follows from the following considerations. In the case of a limited number of objectives with different apertures, one can generate a common HFT, as shown in FIG. 4 in the example with three pupil radii. However this requires a beam former before the HFT, which can be achieved on its part by means of a diffractive element (see SF in FIG. 2). If only a thin ring is used in each case, the losses in the fluorescence detection are still acceptable even in this case. For three different pupil radii in all, in which two are smaller by a factor of s₁ and s₂ respectively compared to the maximum radius (s₁=a₁/a, s₂=a₂/a in FIG. 4), one obtains V=(1−ε²)·(1+s₁²+s₂²) as the loss in the illumination light at the maximum radius.

For example, for s₁=0.6 and s₂=0.4, one obtains V=6% for ring size 0.02 times (1−ε) of the respective ring radius. The advantage in the arrangement realized in this manner lies in the exact justification of the HFT, which is possible with a stationary arrangement in the beam path.

Case B in FIG. 2B shows another advantageous embodiment of the HFT comprising intersecting landing plates with small thickness (see FIG. 2B). A special advantage of such an HFT is its suitability for all practically relevant pupil radii so that the abovementioned adjustment problems are eliminated. Assuming a landing plate width of b and full pupil radius a, the loss in the fluorescence V=4·a·b/(π·a²)=4·b/(π·a).

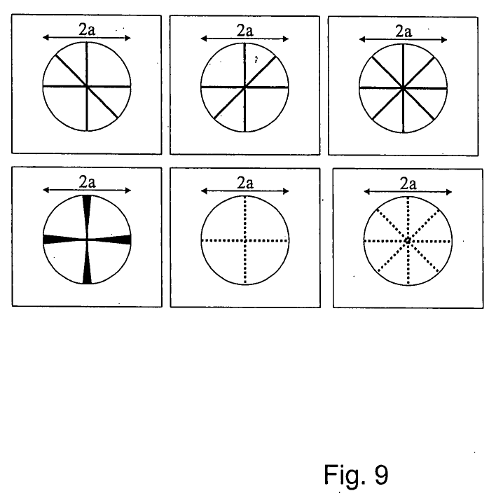

With plate width of b=0.02a, for instance, one obtains losses <3%. When the same HFT is used for an objective with aperture 0.4a, the losses increase to 16%. With linear adaptation of the plate width according to the distance r from the center so that b/r=const. (see FIG. 9), one obtains constant low losses irrespective of the pupil radius.

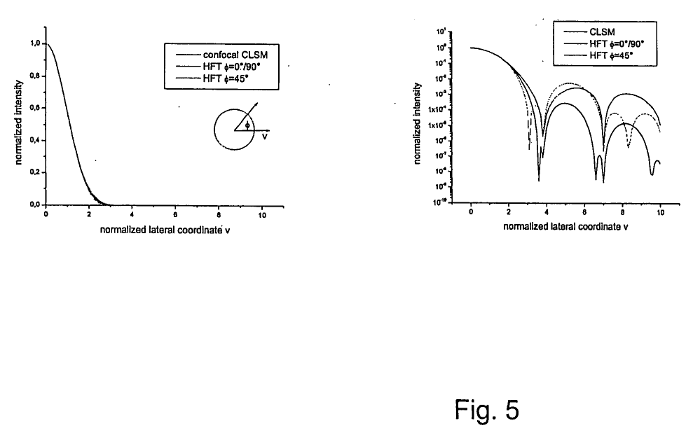

FIG. 5 shows the lateral PSF for two different sections. The PSF is symmetrical for the most part despite lack of rotational symmetry of the HFT.

Shown are the linear (left) and the logarithmic (right) diagrams of the lateral PSF for the confocal case according to the state of the art confocal laser scanning microscope (CLSM) and with the HFT according to the invention (crosswise, landing plates are assumed infinitely thin in this case). The normalized lateral coordinate is v=2π/λNA r. λ_{exc}=488 nm, λ_{fluo}=520 nm.

Near the optical axis, the axial distribution of the PSF is identical to the confocal case according to the state of the art. There are visible but minor differences only far from the axis beyond v>2. The image characteristics are therefore actually practically identical to those in CLSM in this case.

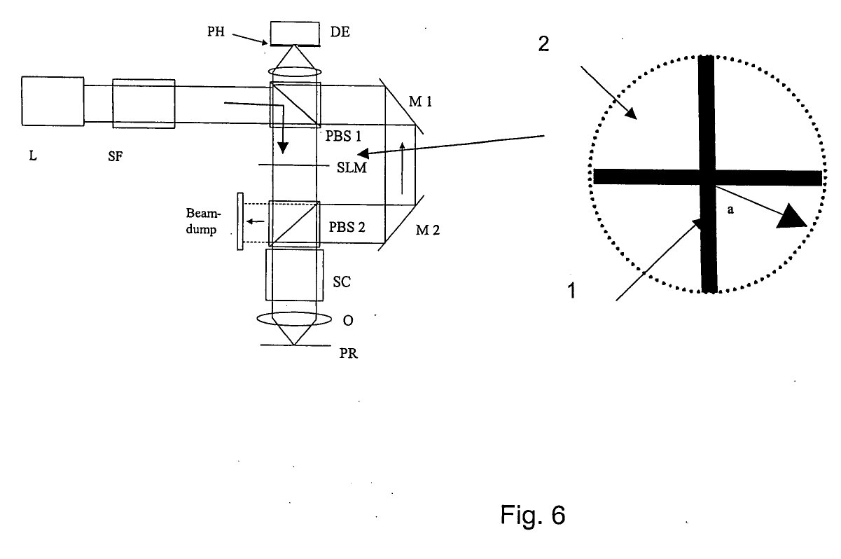

Another embodiment uses a freely programmable HFT, as it can be realized for example with a Spatial Light Modulator (SLM). A possible embodiment is shown in FIG. 6.

In addition to the free programming of the HFT, such an arrangement has the advantage of reduced losses, because the losses of 1−ε² as described above occur only in the polarization direction of the fluorescence beam. The total losses are thus reduced to half.

Light from the light source L arrives, passing through the beam former SF, to a first polarization beam splitter PBS 1 and is reflected by it due to the corresponding selected polarization of the light source (for example linear) in the direction of the probe PR. On the path to the probe, it passes through an SLM. The latter lies in or near a pupil of the microscope. The SLM can be so regulated that the pixels in the black area (1) [see enlarged view of SLM] rotate the polarization of the excitation beam. The excitation beam from these areas thus passes through the second polarization beam splitter PBS 2. The remaining pixels (area 2) do not lead to any change in the polarization. Therefore, these parts of the excitation light are reflected in the direction of beam dump. Instead of a beam dump, a detector can also be arranged for monitoring of the power of the excitation beam.

If the polarization of the light source is not set in such a manner that it is completely reflected in PBS 1, these parts of the beam also reach the beam dump passing through the mirror M1/M2 and PBS 2.

The fluorescence light generated in the probe is split in PBS 2 into two polarized parts transversal to each other. One part is reflected in PBS 2 and reaches the detector after passing through M2/M1 and reflection at PBS 1. The part passing through PBS 2 arrives at the PBS 1 passing through the SLM (area 2), combines there with the reflected part and also reaches the detector. Only the part of the fluorescence light incident on the area (1) is lost.

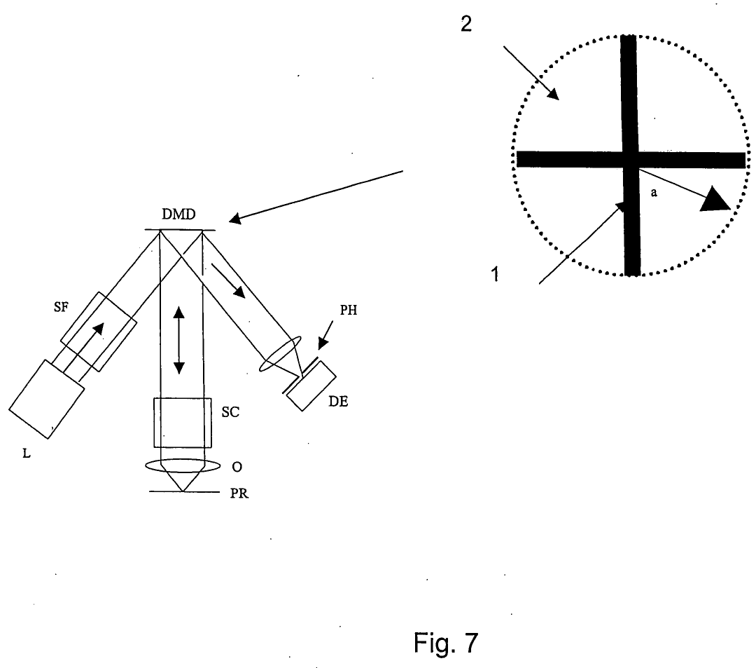

FIG. 7 shows an arrangement according to the invention, in which a micromirror array DMD is used as HFT. Light from the light source L arrives passing through the beam former SF on the DMD, which is arranged in or near a pupil of the microscope. A DMD consists of micromirrors (pixels) arranged in a matrix, which can be switched individually between at least two final statuses. The mirrors (pixel) of the DMD in the black area (1) are switched in such a manner that the excitation in the direction of probe PR is reflected. The detection beam, which is incident on the remaining pixels (area 2), reaches the direction of detection. The part of the fluorescence light incident on the area (1) is lost.

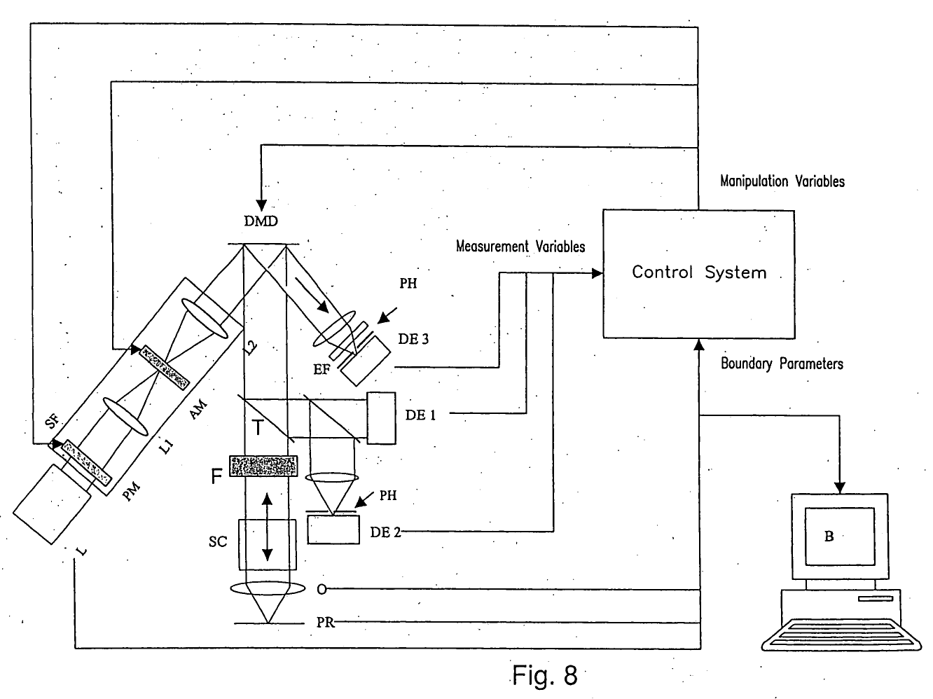

With the help of the arrangements as in FIG. 6 and 7, the greatest variety of different illumination patterns in the pupils of the microscope can be realized for beam separation. The illumination patterns SF and the patterns for the beam splitting at the HFT can also be generated automatically with a control circuit—see FIG. 8.

Thereby the following, in part mutually dependent, measured quantities, serve as the automatic control parameters:

1.) The confocality of the microscope, which can take place, for example, through the measurement of the confocal signal on DE3. Either test probes (like fluorescent beads or thin fluorescence layers) or actual probes that are to be examined, can be used as probes. Use of test probes makes sense if the probe to be actually examined cannot be exposed to the dose of the illumination during the regulation. The regulation is manipulated in a way that preferably the signal with the amplitude as high as possible is measured at DE 3.

2.) The efficiency in the excitation beam path can be measured with a far-field detector at DE1. Thereby the signal should preferably be large as much as possible.

3.) The STREHL ratio of the excitation is measured with a confocal detector DE 2. Thereby the signal should preferably be as large as possible.

4.) From the position of the mirrors of the DMD or the pixel in the SLM, the area/efficiency of the beam splitter can be determined (ratio of the areas 1 to 2 in FIG. 2). The efficiency of the beam splitter should be as high as possible, that is, the area 1 should be as small as possible and the area 2 should be as large as possible.

The corresponding individual sizes can also be optimized. For example, both the efficiency as well as the resolution can be maximized by optimizing the measured variable I). In yet another variant, by optimizing the ratio of 1) to 2), the resolution and efficiency can have relative weights in the regulation.

For that, the splitter T is swiveled optionally into the beam path so that a part of the excitation light (for example 5%) is reflected on DE1 and DE2. The light as such is measured with the detector DE1, with DE2 the excitation-side point image and with the actual detector DE3, the detection-side point image through DMD.

In addition to that, the measurement 1) can take place with a fluorescence generating medium (F). For that purpose, it is swiveled into the beam path between the HFT and the scanner SC. For example, plane-parallel fluorescence optical cells (dye preferably matching to the stain used in the probe) or plane-parallel fluorescing glasses (for example erbium doped glasses) can be used. Preferably, F is so designed that no excitation light reaches in the direction of the probe. After the optimization of the microscope, that is, for the actual measurement of the probe, the splitter T and the probe F are swiveled out again for the actual measurement of the probe.

The HFT (comprising a DMD, SLM or different mirror masks as in FIGS. 2/6/7) and the beam former SF serve as the manipulating parameters for the regulation. In the beam former, the phase and amplitude are set at PM and AM. In the HFT, the patterns of the areas 1 or 2 are varied.

As the boundary parameters, the input parameters serve the purpose here, such as the type of the probe PR, the objective O, the light source and the operation mode B used by the user (for example, high or low depth of sharpness, high efficiency in the excitation, high efficiency in the detection). Preferably, these boundary parameters themselves automatically induce the corresponding optimization of the measured variables.

Surprisingly, the adjustment of the geometry with the regulator circuit of the splitter according to the invention can also be applied in the arrangements according to U.S. Pat. No. 6,888,148. Other similar arrangements of HFT, which are based on modifications of the previously mentioned arrangements, can be realized. Besides the ring-shaped arrangements, this is of relevance in particular when more landing plates are used (case A), for example, under 45, degrees with respect to the landing plate in the case A, use of landing plates with uneven thickness (for example, in the case A, landing plates that become thicker at the borders) landing plates with partial gaps (A and B) and combinations of these cases.

Several possible examples are shown in FIG. 9. The external border of the pupil is thereby to be understood as a symbolic marking. In the sense of a combination of the variants of main dichroic beam splitter as in the cases A and B, this can however also mean a ring-shaped reflecting zone. By including more landing plates, a more symmetrical point-image function in the excitation beam is obtained (FIG. 9, upper row of images). This can be meaningful in the realization of a focus volume that is as small as possible. By varying the width of the landing plate (FIG. 9, bottom left image), the splitting efficiency can be maintained constant irrespective of the size of the pupil of the objective. With a gap in the landing plates (FIG. 9, bottom middle and right images), the efficiency of the beam splitting is increased without worsening the resolution.

The landing plates can cross each other in a star-like manner, with an even or odd number of plates. The plates can also be arranged in spider-like form, with a common center in the optical axis or outside the optical axis. Such arrangements of the plates can be combined with ring arrangements, and instead of the rings, spiral-shaped structures can also be provided or there can be several eccentrically arranged small rings or one—or several—triangles or other geometric figures, and other amplitude or phase patterns are also possible and can be adjusted, whereby the optimization can take place through the manipulation as described above.

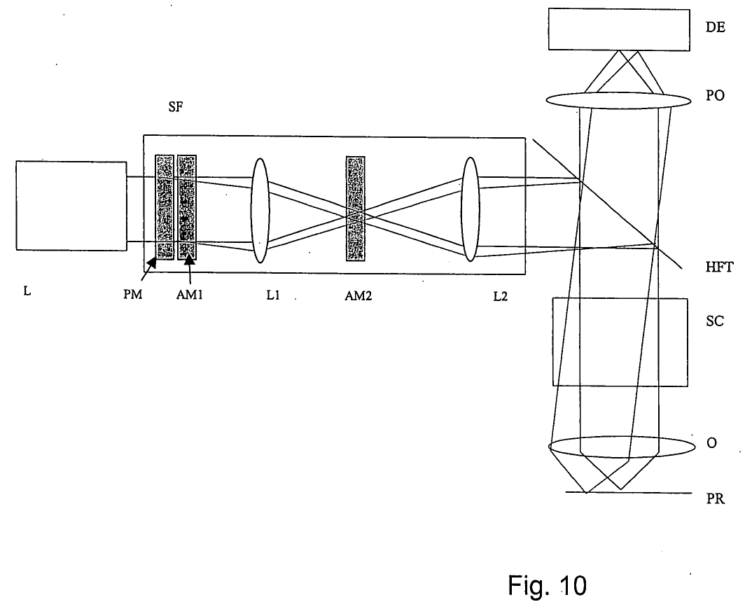

In a Nipkow or a multipoint scanning microscopy system, the main dichroic beam splitter is substituted according to the invention by a patterned beam splitter and is arranged in or near a pupil. FIG. 10 shows by way of illustrating the arrangements according to the invention for a multipoint scanning microscope. This is characterized in that several probe points are illuminated and/or deflected at the same time. The point patterns can, for instance, be generated by means of the phase mask PM in combination with the amplitude masks AM1 and AM2 or with other methods according to the state of the art (for example, with microlens arrays or special beam splitter arrangements (LaVision Biotec)). The split excitation beams reach the common regions of the achromatic splitter HFT at different angles (for example area 1) and are reflected there in the direction of the probe. The probe light of the different illumination points reaches the common regions (region 2) of the achromatic splitter and from there it is directed in the direction of the matrix detector DE. Detector elements of DE are arranged in such a manner that they correspond to the illumination patterns in the probe.

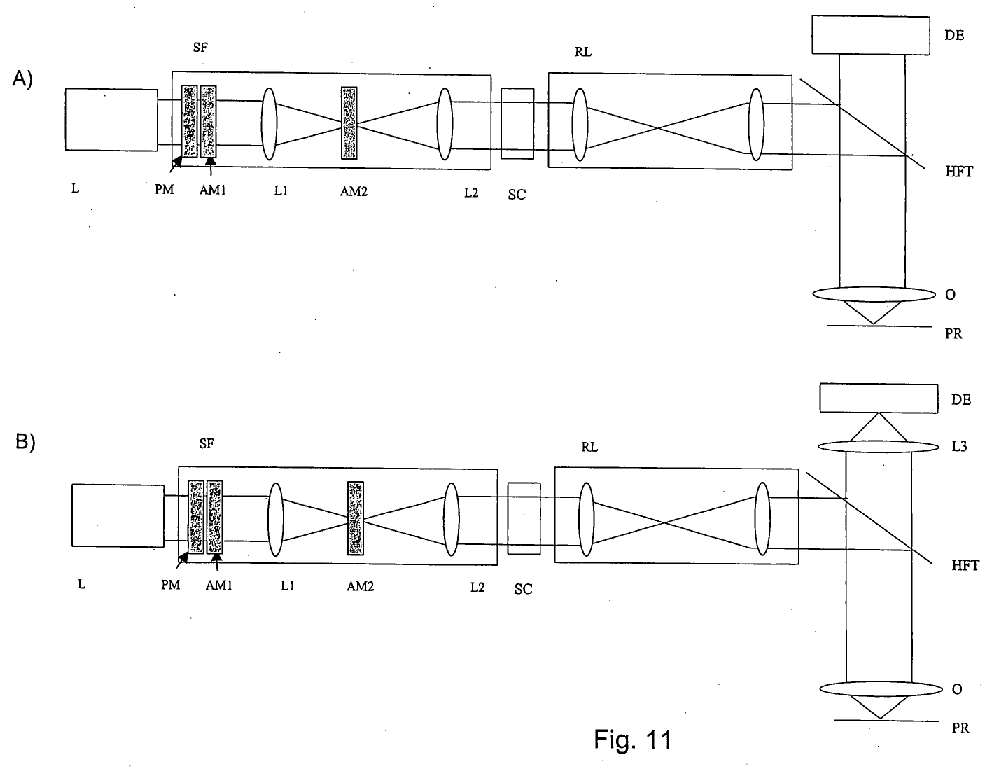

FIGS. 11A and 11B show the arrangements for non-descanned detection according to the invention, as used for instance in multiphoton microscopes. In contrast to the arrangements previously described, the scanner SC in the microscope pupil lies between the light source L and the achromatic beam splitter HFT. The effect and the function of the beam former is analogous to the previously described arrangement. The detection beam reaches directly (without descanning) to a detector DE. With the help of the relay optic RL, an image of the scanner pupil forms at the pupil of the HFT. RL can be dispensed with, if the scanner can be arranged spatially directly before the HFT. In addition the HFT can also be embodied as a scanner, so that SC and HFT can be combined into one. In multiphoton microscopy, the detector is preferably arranged in a microscope pupil (FIG. 11A). In addition to that, the detector can also be located in an intermediate image (formed by L3) (FIG. 11B), so that it can detect the probe signals with spatial resolution.

1. A point scanning Laser Scanning Microscope comprising:
a probe:
a detector;
a pupil plane of a beam path between the probe and the detector for separation of an illumination beam and a detection beam;
an element arranged in or near the pupil plane, the element including a reflecting or a transmitting first region for the transmission of the illumination beam and a second transmitting or reflecting region, lying essentially outside the first region, for the transmission of light from the probe.

2. A point scanning Laser Scanning Microscope comprising:
a probe;
a detector;
a pupil plane of a beam path between the probe and the detector for separation of an illumination beam and a detection beam;
an element arranged in or near the pupil plane, the element including a reflecting or a transmitting first region for the transmission of the illumination beam and a second transmitting or reflecting region, lying essentially outside the first region, for the transmission of light from the probe; and
manipulating means for varying the size and/or the form of the first region and/or second region.

3. The point scanning Laser Scanning Microscope according to claim 1, further comprising means for influencing the phase and/or the amplitude of light from the illumination beam.

4. The point scanning Laser Scanning Microscope according to claim 1, further comprising a beam former for generation of beam forms.

5. The point scanning Laser Scanning Microscope according to claim 4, wherein illumination patterns are generated by the beam former and imaged in the pupil plane.

6. The point scanning Laser Scanning Microscope according to claim 1, whereby the element for the transmission of the illumination pattern is reflective, and the element for the transmission of the probe light outside the reflecting region or regions is transmissive.

7. The point scanning Laser Scanning Microscope according to claim 1, wherein one or more first or second regions are each imaged in an annular shape.

8. The point scanning Laser Scanning Microscope according to claim 1, wherein one or more first or second regions each comprise a landing plate.

9. The point scanning Laser Scanning Microscope according to claim 1, further comprising several landing plates each with a common crossing point.

10. The point scanning Laser Scanning Microscope according to claim 9, wherein the crossing point of each landing plate lies on an optical axis.

11. The point scanning Laser Scanning Microscope according to claim 9, wherein each landing plate has a gap.

12. The point scanning Laser Scanning Microscope according to claim 1, wherein the element HFT comprises a plate and is reflective.

13. The point scanning Laser Scanning Microscope according to claim 1, wherein the element HFT comprises an SLM, which manipulates polarization.

14. The point scanning Laser Scanning Microscope according to claim 1, whereby the element HFT comprises a DMD, which deflects the beam, that has a different angle for illumination and detection.

15. A method for adjusting a microscope, comprising the steps of:
providing a pupil plane of a beam path between a probe and a detector for separation of an illumination beam and a detection beam;
arranging an element arranged in or near the pupil plane, the element including a reflecting or a transmitting first region for the transmission of the illumination beam and a second transmitting or reflecting region, lying essentially outside the first region, for the transmission of light from the probe; and
varying the size and/or the form of the first and/or the second region through the use of manipulating devices under the control of a control circuit.

16. The method according to claim 15 further comprising the step of providing a far-field microscope as the microscope for adjustment.

17. The method according to claim 15 further comprising the step of providing the microscope with a line-shaped distribution of illumination.

18. The method according to claim 15 wherein the microscope to be adjusted is a point scanning microscope.

19. The method according to claim 15 wherein the microscope is provided with several point-like sources of light.

20. The method according to claim 15, wherein as the control or the measurement variable, the intensity and/or the wavelength of the illumination beam and/or the intensity and/or the wavelength of the probe light and/or the intensity and/or the wavelength of a test probe and/or the Strehl ratio of an excitation beam are used.

21. The point scanning Laser Scanning Microscope according to claim 1 with a Nipkow scanner or a multipoint scanner.

22. The point scanning Laser Scanning Microscope according to claim 1 with multiphoton excitation and in particular non-descanned detection.
